(19) United States
(12) Patent Application Publication
(10) Pub. No.: US 2013/0043988 A1
(43) Pub. Date: Feb. 21, 2013

(54) PILLOWCASE ALARM CLOCK

(71) Applicant: James E. Bruno, Orlando, FL (US)

(72) Inventor: James E. Bruno, Orlando, FL (US)

(21) Appl. No.: 13/642,805

(22) PCT Filed: Apr. 26, 2011
(86) PCT No.: PCT/US11/33891

§ 371 Date: Oct. 22, 2012

Related U.S. Application Data
(60) Provisional application No. 61/328,707, filed on Apr. 28, 2010.

(51) Int. Cl. G08B 6/00

(52) U.S. Cl. 340/407.1

(57) ABSTRACT

A pillowcase alarm system is provided. The system includes a pillowcase adapted to receive a pillow; a printed circuit board, microcontroller and RF transceiver; at least one vibration motor; and executable code causing a cellular telephone, smartphone or computer to communicate wirelessly with the system; view the status of the system; and configure the user defined alarm settings. The complete system is designed to provide the user an adaptable waking experience while maintaining the integrity of the pillow and bedding.

### RELATED APPLICATIONS

This application claims priority from U.S. Provisional Patent Application Ser. No. 61/328,707 filed Apr. 28, 2010; and International Application No. PCT/US2011/038891 filed Apr. 26, 2011, incorporated herein in their entirety by reference.

### FIELD OF INVENTION

The present invention relates to an alarm system housed within a pillowcase and more particularly, pertains to a pillowcase alarm system configurable by an external software application.

### BACKGROUND OF THE INVENTION

Commonplace in almost every household is some form of an alarm clock device. Traditionally, alarm clocks were simple mechanical devices, but with the rapid pace of technological advances, we now have cellular telephones and smartphones with built-in alarm capabilities. Due to the configurability and freedom offered by today's cellular telephones and smartphones, many choose to relegate their morning wake routine to these all-in-one devices. Typically, these devices provide the user several different waking experiences including music, vibration and tones configurable over a range of volumes and intensities. Thus, based on a user's varying waking requirements, the cellular telephone or smartphone has become the alarm clock of choice. In this regard, due to their convenient size, many choose to place the cellular telephone or smartphone on the bed or underneath the pillow. Unfortunately, doing so may alter the comfort of the bed or pillow and heightens the risk of damage to the phone.

Concurrently with the rapid pace of technological advances and in an attempt to address user's varying waking requirements, many alarm clock configurations have been devised that encompass a broad range of operation and functionalities. An example of these configurations is the development of pillow alarm clock devices. For example, see U.S. Pat. No. 7,266,047 to Chan, U.S. Pat. No. 7,461,422 to Baker, U.S. Pat. No. 6,236,621 to Schettino and U.S. Pat. No. 5,072,429 to Mair. Generally, these devices consist of alarm clock devices built into the pillow itself or configured to be placed underneath the pillow therefore suffering from the same shortcomings of a cellular telephone or smartphone placed within the sleep area of the user. While these devices may be suitable for the particular purpose to which they address, they are not suitable for the purpose of the present invention as hereinafter described.

### SUMMARY OF THE INVENTION

Various exemplary embodiments as described herein address the desirable aspects lacking in the relevant art and provide in various exemplary systematic embodiments a system directed toward a pillowcase alarm clock configurable by an external software application.

Accordingly, in a preferred aspect, the pillowcase alarm system comprises a pillowcase having an interior and an exterior surface, the pillowcase having an opening formed along an edge thereof adapted to receive a pillow. The operation of the system is controlled by a printed circuit board (PCB) with a microcontroller mounted thereto. The PCB and microcontroller are preferably located on the interior surface of the pillowcase and electrically connect to at least one vibration motor.

In a further aspect, the at least one vibration motor is located on the interior surface of the pillowcase. The components of the invention located on the interior surface of the pillowcase are housed within a padded lining constructed from a sound conducting material. As such, the comfort of the pillow is retained.

In yet a further aspect, the printed circuit board comprises a RF transceiver for communicating wirelessly with a device selected from at least one member of the group consisting of a cellular telephone, smartphone and computer. The RF transceiver is preferably a Bluetooth®/Wi-Fi® transceiver.

In yet a further aspect, the pillowcase alarm system comprises executable code causing the device selected from at least one member of the group consisting of a cellular telephone, smartphone and computer to: communicate wirelessly with the system; view the status of the system; and configure the user defined alarm settings.

In another aspect, the printed circuit board comprises an USB port for communicating with a device selected from at least one member of the group consisting of a cellular telephone, smartphone and computer. In this aspect the USB port is accessible through the opening in the pillowcase adapted for receiving a pillow thereby retaining the components of the invention on the interior surface of the pillowcase.

In yet a further aspect, the pillowcase alarm system comprises at least one function button electrically connected to the microcontroller and configured to operate the system. The at least one function button provides the user with snooze and on/off functionality. As with the other components of the system, the at least one function button is located on the interior surface of the pillowcase and housed within a sound conducting material.

In another aspect, the pillowcase alarm system comprises an auditory alarm generated by at least one speaker. The at least one speaker provides the user with alternative waking experiences in the form of tones and/or music. As with the other components of the system, the at least one speaker is located on the interior surface of the pillowcase and housed within a sound conducting material. The at least one speaker may be used in singularly or in combination with other speakers or vibration motors.

In yet another aspect, the electrical components of the pillowcase alarm system are water-resistant. As such, the pillowcase alarm system is machine washable. The electrical components include the PCB, microcontroller, transceiver, vibration motors, function buttons, speakers and associated electronic circuitry. The pillowcase alarm system is powered by a battery located on the interior surface of the pillowcase.

It is contemplated that any method, system or information described herein can be implemented with respect to any other method, system or information described herein.

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents and other references mentioned herein, are incorporated by reference in their entirety. In case of conflict, the present specification, including definitions will control.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIG. 1 illustrates a perspective view of the preferred embodiment showing the inner components of the of the present invention;

FIG. 2 illustrates a perspective view of an alternative embodiment of the present invention housed within a mattress pad;

FIG. 3 is a circuit diagram showing the preferred embodiment of the invention with Bluetooth® capabilities;

FIG. 4 is a circuit diagram showing an alternative embodiment of the invention with USB connectivity;

FIG. 5 is a circuit diagram showing an alternative embodiment of the invention with a built-in Liquid Crystal Display (LCD); and

FIG. 6 is a flow diagram illustrating the steps in configuring the preferred embodiment for operation.

FIG. 7 is a graphical interface illustrating the readout and means for programming a pillowcase alarm clock;

FIG. 8 is a graphical interface illustrating the readout and means for programming a mattress pad alarm clock;

### DETAILED DESCRIPTION OF THE INVENTION

The present invention relates to a pillowcase alarm system. The present invention will be described in relation to use of the invention in combination with a pillowcase. However, it will be appreciated that, with minor modifications, the system may be adapted for use with a mattress pad, duvet cover or other bedding items or linens in contact with the user.

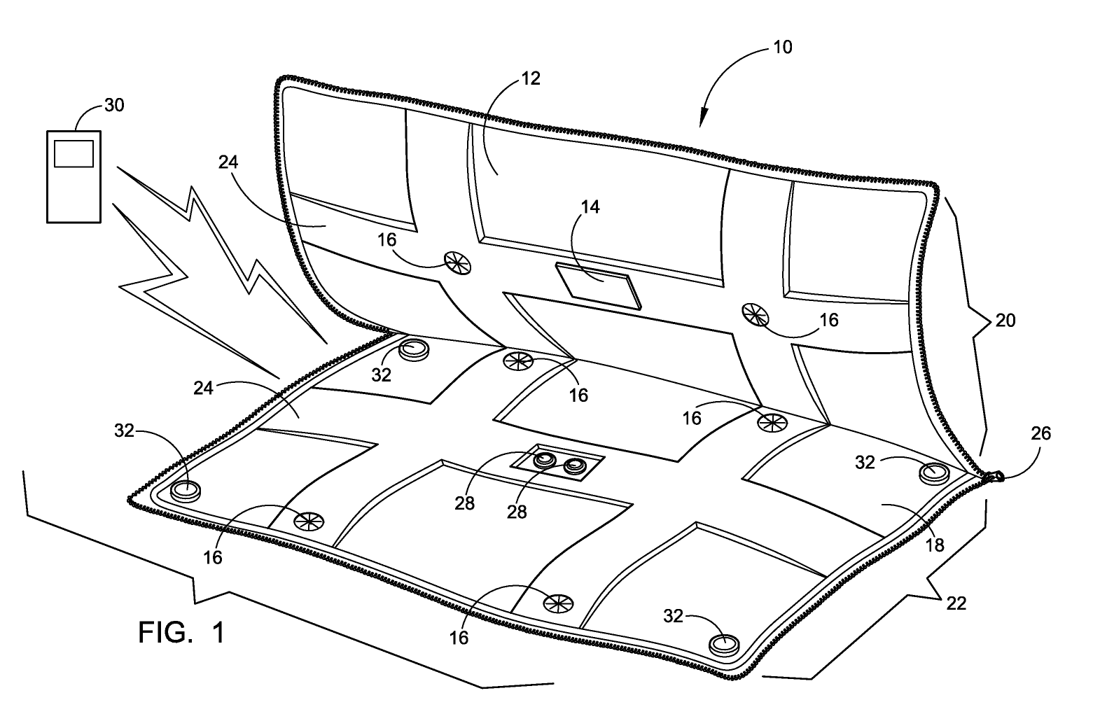

Referring now to the drawings and more specifically FIG. 1, there is shown an open configuration of the pillowcase alarm system 10 comprising a pillowcase 12, a printed circuit board (PCB) 14, including a microcontroller (not shown), and at least one vibration motor 16. The pillowcase 12 has an inner surface 18, top half 20 and bottom half 22 on which the PCB 14, vibration motors 16 and circuitry (not shown) are located. For ease of explanation, the top-half and bottom-half designations are as represented in the orientation of FIG. 1, but it is to be understood that this is merely a formality and dependent upon the user's preferred orientation in which the designations may be reversed. In the preferred embodiment, a padded material 24 constructed from a sound conducting material is used to conceal the various components of the invention and form a padded barrier between the user in contact with the outer surface and the components within such that when in use, the components are undetectable by the user. The sound conducting material may be in a cross-hatch design as in FIG. 1 or one continuous sheet covering the entire interior surface 18 of the pillowcase 12. Alternatively, the components may be concealed by any material that does not alter the characteristics of the bedding item covered by the alarm system 10.

The pillowcase 12 can be designed to fit all industry standard pillows and can be made from any material including cotton, wool, linen, synthetic fibers and blends thereof. In the preferred embodiment, the pillowcase 12 has a three-sided zipper 26 along the periphery thereof for allowing the pillowcase 12 to receive any standard pillow (not shown). Alternatively, the pillowcase 12 is sealable around a standard pillow using any number of fastening devices including hook and look, buttons, snaps and the like. Additionally, the pillowcase 12 in a closed configuration (not shown) is designed to be covered by any decorative pillowcase to match the user's bed linens and room decor. As such, the pillowcase alarm system 10 with no cords is undetectable resulting in a clean, appealing bedroom decor.

In the preferred embodiment, the pillowcase alarm system 10 is powered by at least one battery 28. Preferably, the battery is a lithium coin battery. Alternatively, the pillowcase alarm system 10 may be powered by a power source that may be any small form, high capacity battery, cylinder type battery or switching mode DC transformer. In an alternative embodiment the pillowcase alarm system 10 includes a rechargeable small form, high capacity battery and recharging circuitry for receiving power through an electrical power cord and AC unit or through a USB connection.

In use, the pillowcase alarm system 10 alerts the user at a predetermined wake time through vibration motors 16. The vibration motors 16 are miniature, magnetic coin style or cylindrical water-resistant motors similar to the ones found in cellular telephones and smartphones. Due to the use of padded material 24, the vibration motors 16, singularly or in any numerical combination, can be located anywhere on the interior surface 18 of the pillowcase 12. In a preferred embodiment, two vibration motors 16 are located on the periphery of the bottom half 22 of the interior surface 18 of the pillowcase 12. Two additional vibration motors 16 are more centrally located on the top half 20 of the interior surface 18 of the pillowcase 12. In an alternative embodiment, the alarm system 10 includes additional vibration motors 16 located on the periphery opposite to those described in this paragraph.

The vibration motors are controlled by and electrically coupled to the PCB 14 wherein are mounted a microcontroller and in the preferred embodiment, a Bluetooth® or Wi-Fi® transceiver (not shown). The PCB 14 is mounted on the inner surface 18 of the top-half 20 of pillowcase 12.

The microcontroller is any single chip that contains the processor, non-volatile memory for the program, volatile memory for the I/O, a clock and an I/O control unit. The microcontroller can be of 8, 16 or 32 bit architecture and produced by any microcontroller manufacturer including Zilog, Texas Instruments, Microchip, Intel, National Semiconductor, Toshiba or Parallax.

The transceiver facilitates the remote exchange of data and synchronizing signals between a cellular telephone, smartphone or computer 30 and the pillowcase alarm system 10. By way of example only, the transceiver is a Bluetooth® transceiver and may be of the type manufactured by Roving Networks, Broadcom, Texas Instruments or BluePacket. The transceiver is envisioned to be of a type normally associated with computer networks based on the various IEEE standards 802.x, where x denotes the various present and evolving wireless computing standards, for example IEEE 802.11 a, b, g, n or 802.15. In an alternative embodiment, a standard USB port is coupled to PCB 14 facilitating communication with the cellular telephone, smartphone or computer 30.

Included in the alarm system 10 are function buttons 32 preferably located at the four corners of the interior surface 18 of pillowcase 12. The function buttons 32 provide the user snooze and on/off functionality. It is to be understood that the function buttons 32 may be singular or in any numerical combination located anywhere on the interior surface 18 of the pillowcase 12.

The pillowcase alarm system 10 is controlled by software. The software enables the user to communicate with the system; view the status of the system; and configure the user defined alarm settings. The software is available for the iPhone®, Android® and Windows® smartphones as well as computers with operating systems including the various versions and derivations of Unix™, Microsoft Windows®, and Apple® MAC Os-X.

The novel features of the various embodiments, as well as the invention itself, both as to its structure and its operation, will be best understood from the accompanying non-limiting examples, taken in conjunction with the accompanying description.

### EXAMPLES

### Example 1

### Pillowcase Alarm System with Bluetooth®/Wi-Fi® and USB Capabilities

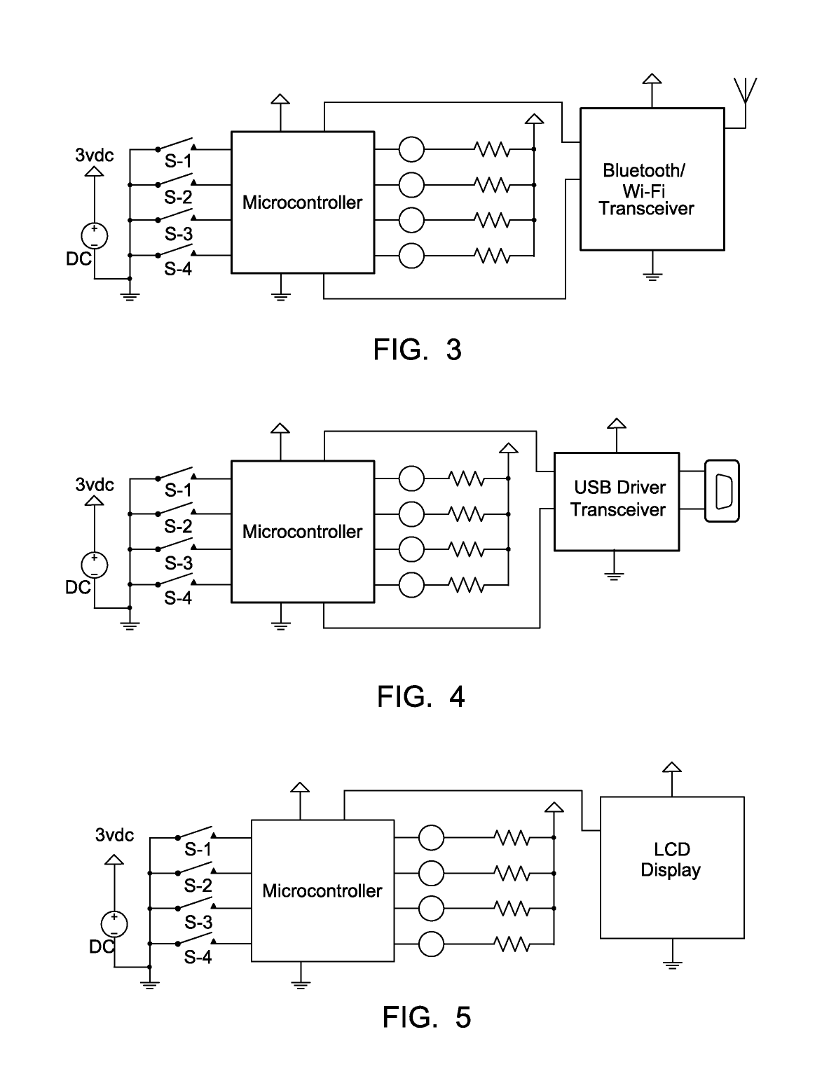

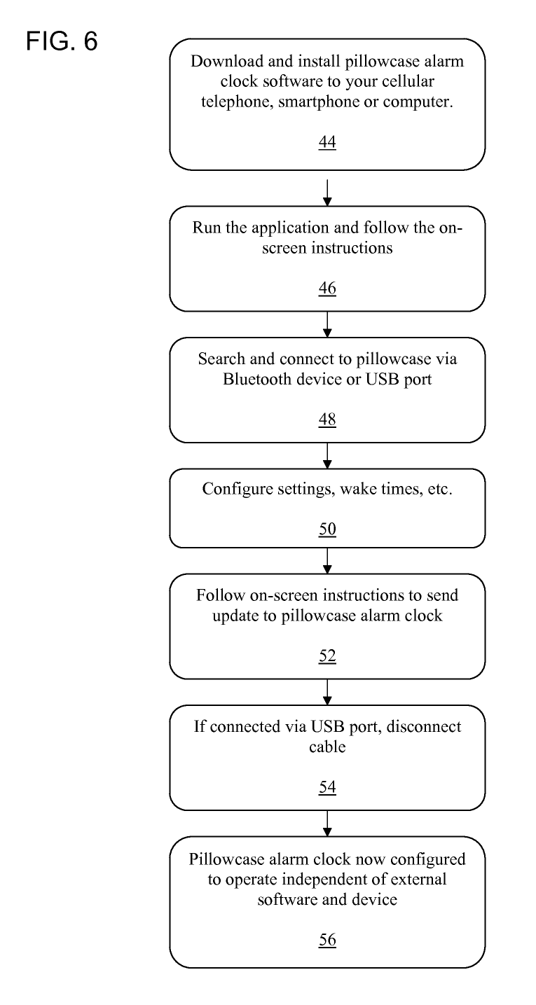

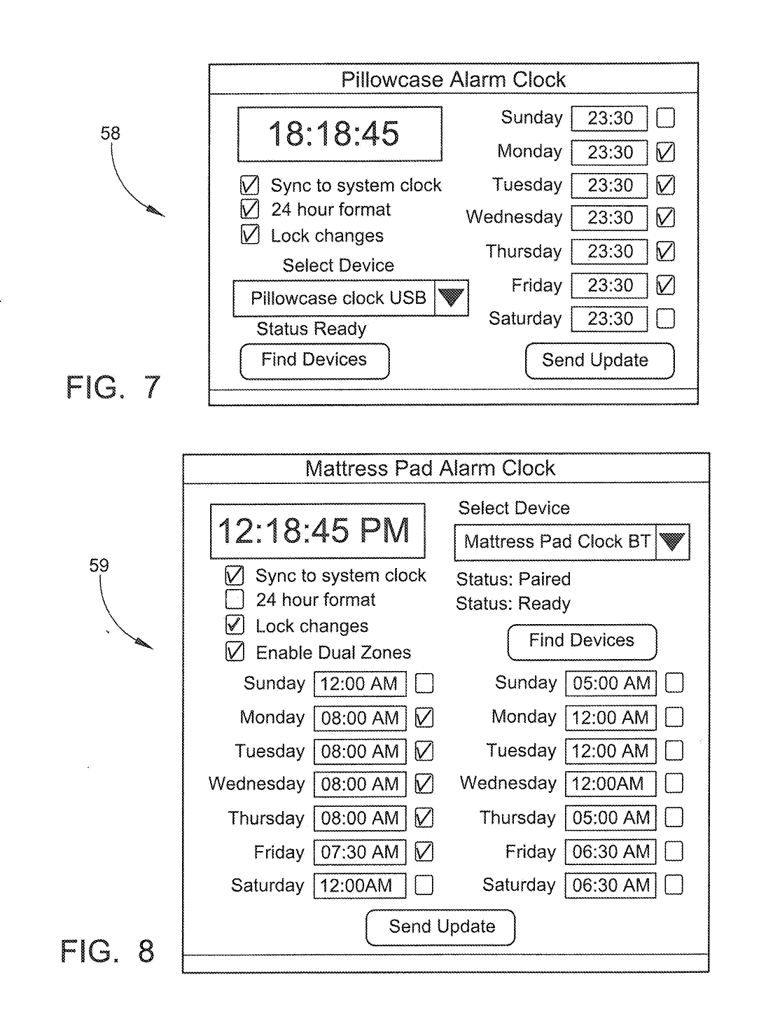

Referring now to FIGS. 3 and 4, a circuit diagram according to the preferred embodiment is shown illustrating the connections of the various components of the alarm system 10. By way of example only, in stepwise fashion as depicted in FIG. 6, an exemplary user session for the alarm system 10 setup is hereinafter described. To view and set the time and alarms for the pillowcase alarm system: Download and install the pillowcase alarm clock software 44 for your Smartphone, tablet or desktop/laptop computer to use the USB or Bluetooth®/Wi-Fi® connections. Run the application 46 and referring now to FIG. 7, the following screen will appear:
1. The current time is set to the time on the phone or computer running the software. If you would like to change it, uncheck the ‘Sync to system clock’ checkbox and enter the desired time into the textbox.
2. Select a 24 hour format by checking the ‘24 hour format’ checkbox; otherwise, a 12 hour format is used.
3. The ‘Lock changes’ checkbox allows locking the wake times so that settings can only be changed from the current device running the setup software.
4. To find your USB or Bluetooth®/Wi-Fi® devices, make sure a USB cable is connected to your pillowcase alarm OR set your pillowcase alarm in Bluetooth®/Wi-Fi® discovery mode by pressing a function button one time.
5. Click the ‘Find Devices’ button 48 and all nearby pillowcase alarm clocks in discovery mode will be found.
6. Once the devices have been found, the status will return to ‘Ready’. Select the device to be setup from the dropdown list.
7. Set the wake times 50 by typing into the textboxes and checking the appropriate checkbox for the days to be activated.
8. Click ‘Send Update’ 52 and the pillowcase alarms will be set.
9. Disconnect USB cables 54 and close the zipper on the pillowcase alarm clock.

### Example 2

### Mattress Pad Alarm System with Bluetooth®/Wi-Fi® and USB Capabilities

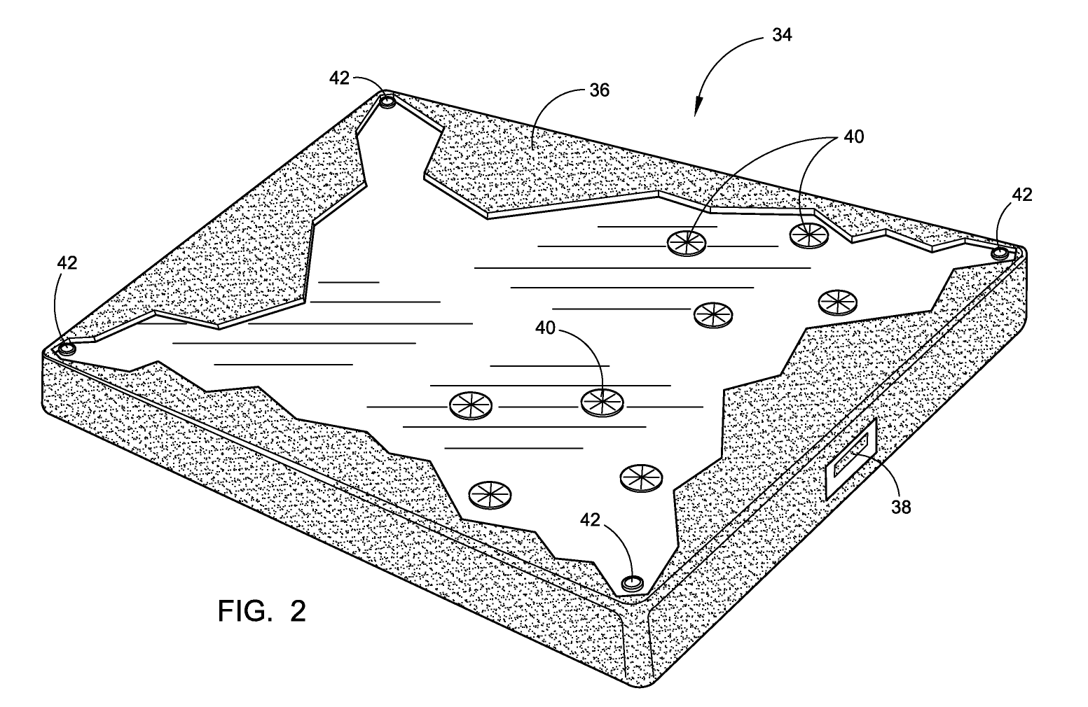

Referring now to FIG. 2, in an alternative embodiment of the alarm system 10, the mattress pad alarm system 34 is configured for use with a fitted mattress pad 36 that can be designed to fit all mattress types and sizes. In this alternative embodiment, the PCB and associated modules 38 may be discretely located at the head of the mattress pad 36. The mattress pad alarm system 34 comprises vibration motors 40 preferably located in the area of the mattress pad 36 associated with the torso region of a user. Alternatively, the vibration motors 40 may be optimally positioned anywhere on the mattress pad 36 most appropriate for delivering the requisite waking experience.

The mattress pad alarm system 34 is designed and functions as described above for the pillowcase alarm system 10. Included in the alarm system 34 are function buttons 42 preferably located at the four corners of the mattress pad 36. The function buttons 42 provide the user snooze and on/off functionality. It is to be understood that the function buttons 42 may be singular or in any numerical combination located anywhere on the mattress pad 36.

An additional feature of the mattress pad alarm system 34 is the ability to be divided into zones. In this embodiment, the software is configured to control the vibration motors 40 either as a single unit with one wake time or to accommodate multiple users by controlling the vibration motors 40 in zones with potentially differing waking times and/or waking experiences.

By way of example only, in stepwise fashion, an exemplary user session according to this embodiment for the alarm system 34 setup is hereinafter described. To view and set the time and alarms for the mattress pad alarm system: Download and install the software for your Smartphone, tablet or desktop/laptop computer to use the USB or Bluetooth®/Wi-Fi® connections. Run the software and referring now to FIG. 8, the following screen will appear:
1. The current time is set to the time on the phone or computer running the software. If you would like to change it, uncheck the ‘Sync to system clock’ checkbox and enter the desired time into the textbox.
2. Select a 24 hour format by checking the ‘24 hour format’ checkbox; otherwise, a 12 hour format is used.
3. The ‘Lock changes’ checkbox allows locking the wake times so that settings can only be changed from the current device running the setup software.
4. To find your USB or Bluetooth®/Wi-Fi® devices, make sure a USB cable is connected to your pillowcase alarm OR set your pillowcase alarm in Bluetooth®/Wi-Fi® discovery mode by pressing a function button one time.
5. Click the ‘Find Devices’ button and all nearby pillowcase alarm clocks in discovery mode will be found.
6. Once the devices have been found, the status will return to ‘Ready’. Select the device to be setup from the dropdown list.
7. If you are using the entire mattress pad as a single zone, set the wake times by typing into the textboxes and checking the appropriate checkbox for the days to be activated.
8. If you are using each half of mattress pad for different waking schedules, check the ‘Enable Dual Zones’ checkbox; set the wake times by typing into the textboxes for each half and checking the appropriate checkbox for the days to be activated.
9. Click ‘Send Update’ and the pillowcase alarms will be set.
10. Disconnect USB cables and close the zipper on the pillowcase alarm clock.

### Example 3

### Pillowcase or Mattress Pad Alarm System with LCD Display

Referring now to FIG. 5, a circuit diagram according to an alternative embodiment is shown illustrating the connections of the various components of the alarm system 10. In this alternative embodiment, an LCD panel (not shown) is coupled to the PCB 14. The LCD panel is used to view the setup of the current time and alarm settings. By way of example only, in stepwise fashion, an exemplary user session for the alarm system setup according to this embodiment is hereinafter described. If the alarm is active, it will need to be cleared before performing any setup activities (see Example 4).
1. Viewing the current time
   a. Press and hold one of the function buttons until ‘View Current Time’ appears on the display; then release the button
      View Current Time
   b. Press and hold a function button until the time appears on the display; then release the button. The current time will remain displayed on the LCD for 5 seconds, and then turn off.
      Su12:01p
2. Setting the current time
   a. Press and hold one of the function buttons until ‘View Current Time’ appears on the display; then release the button
   b. Then quickly press and release the function button until ‘Day Time Setup’ appears on the display
      Day Time Setup
   c. Press and hold one of the function buttons until the blinking text ‘day’ followed by a day (example: ‘Su’, ‘Mo’, etc.) appears on the display; then release the button
      day.Su
   d. Quickly press and release the function button to change days until the current day is displayed
   e. Then press and hold one of the function buttons until the blinking text ‘hour’ followed by an hour (example: ‘12p’, ‘1p’, etc.) appears on the display; then release the button
      hour.12p
   f. Quickly press and release the function button to change hours until the current hour is displayed
   g. Then press and hold one of the function buttons until the blinking text ‘min’ followed by a minute (example: ‘01’, ‘02’, etc.) appears on the display; then release the button
      min.01
   h. Quickly press and release the function button to change minutes until the current minute is displayed
   i. Press and hold one of the function buttons until the time appears on the display; then release the button. The time will remain displayed on the LCD for 5 seconds, and then turn off.
      Su12:01p
3. Viewing the wake times
   a. Press and hold one of the function buttons until ‘View Current Time’ appears on the display; then release the button
   b. Then quickly press and release the function button until ‘View Waking Times’ appears on the display
      View Waking Times
   c. Then press and hold one of the function buttons until ‘Su’ appears followed by a time (i.e., 08:25a); then release the button. Each day will appear for 2 seconds with the associated waking time on the display. If the alarm is disabled for the day, ‘Off’ will be displayed.
      Su.Off
      Mo08:25p
      Tu12:30a
   d. After Saturday's time has been displayed the LCD will turn off.
      Sa.Off
4. Setting the wake times
   a. Press and hold one of the function buttons until ‘View Current Time’ appears on the display; then release the button.
   b. Then quickly press and release the function button until ‘Wake Time Setup’ appears on the display
      Wake Time Setup
   c. Press and hold one of the function buttons until the blinking text ‘Su’ followed by an hour (example: ‘12a’) or the word ‘OFF’ appears on the display; then release the button.
      Su.Off
   d. Then quickly press and release the function button until desired wake hour appears on the display. If ‘Off’ is selected, the minutes setup (step 4e) will be skipped.
      Su.12a.h
   e. Press and hold one of the function buttons until the blinking text ‘Su’ followed by an minute (example: ‘21’) appears on the display; then release the button.
      Su.21.m
   f. Press and hold one of the function buttons until the blinking text ‘Mo’ followed by an hour (example: ‘12a’) or the word ‘OFF’ appears on the display; then release the button.
   g. Repeat steps 4d, 4e and 4f for each day of the week.
   h. When complete, each day's wake time will appear for 2 seconds with the associated waking time on the display. If the alarm is disabled for the day, ‘Off’ will be displayed.
      Su.Off
      Mo08:25p
      Tu12:30a
   i. After Saturday's time has been displayed the LCD will turn off.
      Sa.Off

### Example 4

### Alarm System Operation

By way of example only, in stepwise fashion, an exemplary user session for daily operation of the preferred embodiment is hereinafter described.
1. When a preset alarm time has arrived, the vibration motors will begin low intensity vibration.
2. Maximum intensity of the motors will be reached in 5 minutes.

To turn off the alarm:
1. Press and hold one of the four function buttons on the pillowcase alarm clock.
2. Press and hold one of the four function buttons on the mattress pad alarm clock.
3. If in dual zone mode, press and hold one of the two function buttons on each half of the mattress pad alarm clock.
4. The case or pad will respond with 4 short pulses of the vibration motors.
5. Release the snooze button.

NOTE: To maximize battery life, always turn off the alarm after waking.
To snooze:
   1. Quickly press and release a function button.
   2. The alarm cycle will start again in 5 minutes.
      The pillowcase alarm system allows a slumbering user to get the current time without opening their eyes. This is accomplished using sequential pulses of the motors to annunciate the time. For example, 2:13 would be indicated by:
   1. 2 pulsed vibrations.
   2. Short delay.
   3. 1 pulsed vibration.
   4. Short delay.
   5. 3 pulsed vibrations.
      To activate time annunciation, the Pillowcase Alarm Clock must not be in setup or alarm mode.
   1. Quickly press and release a function button.
   2. The time will be annunciated by the vibration motors.

In addition to the non-limiting examples above, it is contemplated that the invention may be practiced with an auditory alarm generated by at least one speaker. The speaker can be any water-resistant, miniature disk type speaker. The at least one speaker may be used in combination with, or in place of, the vibration motors. The location of the speakers will mimic the placement of the vibration motors detailed above and its function controlled by the PCB.

While this invention has been particularly shown and described with references to preferred embodiments thereof, it will be understood by those skilled in the art that various changes in form and details may be made therein without departing from the scope of the invention encompassed by the appended claims.

The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein.

In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of ordinary skill in the art from consideration of the specification and practice of the invention disclosed herein. It is intended that the specification and examples be considered as exemplary only, with a true scope and spirit of the invention being indicated by the claims along with the full scope of equivalents to which such claims are entitled. The disclosures of all articles and references, including patent publications, are incorporated herein by reference.

What is claimed:

1. A pillowcase alarm system comprising:
a pillowcase having an interior and an exterior surface, the pillowcase having an opening formed along an edge thereof adapted to receive a pillow;
a printed circuit board and microcontroller located on the interior surface of the pillowcase; and
at least one vibration motor electrically connected to the microcontroller.

2. The alarm system of claim 1, wherein the at least one vibration motor is located on the interior surface of the pillowcase.

3. The alarm system of claim 2, wherein the at least one vibration motor, printed circuit board and microcontroller are housed within a padded lining constructed from a sound conducting material.

4. The alarm system of claim 1, wherein the printed circuit board further comprises a RF transceiver for communicating wirelessly with a device selected from at least one member of the group consisting of a cellular telephone, smartphone and computer.

5. The alarm system of claim 4, further comprising executable code causing the device selected from at least one member of the group consisting of a cellular telephone, smartphone and computer to: communicate wirelessly with the system; view the status of the system; and configure the user defined alarm settings.

6. The alarm system of claim 1, wherein the printed circuit board further comprises an USB port for communicating with a device selected from at least one member of the group consisting of a cellular telephone, smartphone and computer.

7. The alarm system of claim 1, further comprising at least one function button electrically connected to the microcontroller and configured to operate the system.

8. The alarm system of claim 7, wherein the at least one function button is located on the interior surface of the pillowcase.

9. The alarm system of claim 8, wherein the at least one function button is housed within a padded lining constructed from a sound conducting material.

10. The alarm system of claim 1, further comprising an auditory alarm generated by at least one speaker.

11. The alarm system of claim 10, wherein the at least one speaker is located on the interior surface of the pillowcase.

12. The alarm system of claim 11, wherein the at least one speaker is housed within a padded lining constructed from a sound conducting material.

13. The alarm system of claim 1, wherein the electrical components are water-resistant.

14. The alarm system of claim 1, wherein the system is powered by a battery.

15. The alarm system of claim 14, wherein the battery is located on the interior surface of the pillowcase.

16. A pillowcase alarm system comprising:
a pillowcase having an interior and an exterior surface, the pillowcase having an opening formed along an edge thereof adapted to receive a pillow;
a printed circuit board and microcontroller located on the interior surface of the pillowcase;
at least one vibration motor electrically connected to the microcontroller;
at least one function button electrically connected to the microcontroller; and
a RF transceiver for communicating wirelessly with an external device.

17. The alarm system of claim 16, wherein the at least one vibration motor, at least on function button and RF transceiver are located on the interior surface of the pillowcase.

18. The alarm system of claim 17, wherein the printed circuit board, microcontroller, at least one vibration motor, at least on function button and RF transceiver are housed within a padded lining constructed from a sound conducting material.

19. The alarm system of claim 18, further comprising executable code causing the device selected from at least one member of the group consisting of a cellular telephone, smartphone and computer to: communicate wirelessly with the system; view the status of the system; and configure the user defined alarm settings.

20. A pillowcase alarm system comprising:
a pillowcase having an interior and an exterior surface, the pillowcase having an opening formed along an edge thereof adapted to receive a pillow;
a printed circuit board, microcontroller and RF transceiver located on the interior surface of the pillowcase;
at least one vibration motor electrically connected to the microcontroller;
at least one function button electrically connected to the microcontroller; and
executable code causing a device selected from at least one member of the group consisting of a cellular telephone, smartphone and computer to: communicate wirelessly with the system; view the status of the system; and configure the user defined alarm settings.
